(19) United States
(12) Patent Application Publication
(10) Pub. No.: US 2009/0033001 A1
(43) Pub. Date: Feb. 5, 2009

(54) Manufacture of resin-coated carbon nanomaterial

(75) Inventors: Makoto Kozuka, Hanishina-gun (JP); Yoshihiko Takahashi, Hanishina-gun (JP); Koji Kobayashi, Hanishina-gun (JP)

Correspondence Address: BRUCE L. ADAMS, ESQ.;ADAMS & WILKS, SUITE 1231, 17 BATTERY PLACE, NEW YORK, NY, 10004, US

(73) Assignee: NISSEI PLASTIC INDUSTRIAL CO., LTD.

(21) Appl. No.: 12/221,270

(22) Filed: Aug. 1, 2008

(30) Foreign Application Priority Data
Aug. 1, 2007 (JP) 2007-201185

(51) Int. Cl. B29C 45/00; B01J 13/22

(52) U.S. Cl. 264/328.17; 427/213.31

(57) ABSTRACT

A method for manufacturing a resin-coated carbon nanomaterial whereby an ultrasonic stirring method can be applied even for polycarbonate. A poly-carbonate resin is dissolved in a first organic solvent primarily composed of tetrahydrofuran, and an additive and a carbon nanomaterial are added to the solution, whereby a carbon nanomaterial coated by the polycarbonate resin is obtained. The polycarbonate resin alone cannot withstand ultrasonic stirring, but accompanying the polycarbonate resin with the carbon nanomaterial enables ultrasonic stirring to be applied.

### FIELD OF THE INVENTION

The present invention relates to an improvement in a technique for mixing together a resin material and a carbon nanomaterial.

### BACKGROUND OF THE INVENTION

Attention has recently been given to techniques for making conductive plastic or reinforced plastic by mixing specialized carbon fibers referred to as carbon nanomaterials into plastic.

Carbon nanomaterials are ultra-fine materials, and therefore have the characteristics of being easily aggregated and difficult to disperse in comparison to micron-order carbon powder, and therefore are difficult to handle.

A technique for inducing dispersion using ultrasound has therefore been disclosed in JP 2006-112005 A.

In the method for manufacturing a nanocarbon composite disclosed in JP 2006-112005 A, the nanocarbon is preferably dispersed in a dispersion solution by applying ultrasonic waves. Entanglement between nanocarbon units can thereby be reliably dissolved, and the nanocarbon can be more uniformly dispersed in the solution mixture. As a result, each nanocarbon unit can be more reliably coated by a polyimide-based resin.

However, there are numerous types of resins, among which polycarbonate (PC) is a typical engineering plastic, and is widely utilized in electrical parts, vehicle parts, precision instrument parts, and common machine parts.

A fiber-reinforced polycarbonate obtained by adding a carbon nanomaterial to polycarbonate having such excellent characteristics as described above is anticipated as one example of a composite resin material.

However, when the inventors produced a prototype by an ultrasonic stirring method, the fiber-reinforced polycarbonate did not exhibit the desired enhancement of strength.

The reason for this is considered to be that the ultrasonic waves caused degradation of the polycarbonate, and the additive separated from the polycarbonate, and as a result, the mechanical strength was reduced. It was therefore concluded that an ultrasonic stirring method cannot be applied to stirring polycarbonate.

A mechanical stirring method or the like has been employed in the past as a substitute method to stir the polycarbonate, but mechanical stirring methods are inferior in terms of efficient stirring, and productivity is reduced by increased stirring time. Furthermore, mechanical stirring methods have low dispersion performance in comparison to an ultrasonic stirring method, and the mechanical strength of the composite resin material is not enhanced to expectations.

There is a need for a manufacturing technique whereby an ultrasonic stirring method can be applied even for polycarbonate in order to obtain enhanced productivity and enhanced mechanical strength.

### SUMMARY OF THE INVENTION

An object of the present invention is to provide a manufacturing technique whereby an ultrasonic stirring method can be applied even for polycarbonate.

According to a first aspect of the present invention, there is provided a method for manufacturing a resin-coated carbon nanomaterial, the method comprising: a first preparation step of preparing a first organic solvent primarily composed of tetrahydrofuran, a polycarbonate resin as a first resin material to be dissolved in the first organic solvent, an additive having a functional group for dissolving an ester, and a carbon nanomaterial; a first resin dispersion step of mixing the polycarbonate resin with a portion of the first organic solvent, dissolving the polycarbonate resin in the first organic solvent, and obtaining a first resin dispersion solution; a first stirring step of adding the additive and the carbon nanomaterial to the resulting first resin dispersion solution, and stirring under reflux conditions to obtain a first nanocarbon/resin dispersion solution; a filtering step of filtering the resulting first nanocarbon/resin dispersion solution and obtaining a filtrate; a re-filtering step of adding a residue of the first organic solvent to the resulting filtrate, performing at least one re-filtration, and obtaining a re-filtrate; a washing step of washing the re-filtrate to remove excess polycarbonate resin from the resulting re-filtrate, and obtaining a washed product; and a first drying step of drying the resulting washed product and obtaining a carbon nanomaterial that is coated by a resin.

A carbon nanomaterial coated by the first resin material can thus be obtained by dissolving a polycarbonate resin as the first resin material in a first organic solvent primarily composed of tetrahydrofuran, and adding an additive and a carbon nanomaterial to the solution.

Polycarbonate resin alone is a material that cannot withstand ultrasonic stirring, but accompanying the polycarbonate resin with the carbon nanomaterial enables ultrasonic stirring to be applied. The reason for this is that the carbon nanomaterial exhibits reinforcing effects. The carbon nanomaterial that is coated by the resin can therefore be subsequently subjected to ultrasonic stirring.

Furthermore, in the abovementioned manufacturing method, reduction of the molecular weight of the polycarbonate resin by the additive can be anticipated, and the thickness of the resin coating layer on the carbon nanomaterial can be reduced. As a result, the amount of the first resin material used can be reduced.

The additive is preferably an azo-based compound, or an amine-based complex for forming a complex with copper chloride. Effects whereby the molecular weight of the polycarbonate or other resin material is reduced can be anticipated through the use of an azo-based compound or an amine-based complex for forming a complex with copper chloride.

According to a second aspect of the present invention, there is provided a method for manufacturing a nanocarbon-containing resin material, the method comprising: a second preparation step of preparing a second organic solvent primarily composed of tetrahydrofuran, a second resin material to be dissolved in the second organic solvent, water, and the resin-coated carbon nanomaterial manufactured by a method having a first preparation step of preparing a first organic solvent primarily composed of tetrahydrofuran, a polycarbonate resin as a first resin material to be dissolved in the first organic solvent, an additive having a functional group for dissolving an ester, and a carbon nanomaterial, further having a first resin dispersion step of mixing the polycarbonate resin with a portion of the first organic solvent, dissolving the polycarbonate resin in the first organic solvent, and obtaining a first resin dispersion solution, further having a first stirring step of adding the additive and the carbon nanomaterial to the resulting first resin dispersion solution, and stirring under reflux conditions to obtain a first nanocarbon/resin dispersion solution, further having a filtering step of filtering the resulting first nanocarbon/resin dispersion solution and obtaining a filtrate, further having a re-filtering step of adding a residue of the first organic solvent to the resulting filtrate, performing at least one re-filtration, and obtaining a re-filtrate, further having a washing step of washing the re-filtrate to remove excess polycarbonate resin from the resulting re-filtrate, and obtaining a washed product, and further having a first drying step of drying the resulting washed product and obtaining a carbon nanomaterial that is coated by a resin; a second resin dispersion step of mixing the second resin material with a portion of the second organic solvent, dissolving the second resin material in the second organic solvent, and obtaining a second resin dispersion solution; a nanocarbon dispersion step of obtaining a nanocarbon dispersion solution separately from the second resin dispersion step by mixing the resin-coated carbon nanomaterial with a residue of the second organic solvent and performing ultrasonic stirring; a second stirring step of stirring the resulting nanocarbon dispersion solution while dripping the nanocarbon dispersion solution into the second resin dispersion solution, and obtaining a second nanocarbon/resin dispersion solution; a solvent aqueous phase transition step of adding water to the resulting second nanocarbon/resin dispersion solution and changing a second organic solvent component to an aqueous phase; and a second drying step of removing the second organic solvent and obtaining a resin material that contains a carbon nanomaterial by drying the aqueous-phase-changed solution.

A nanocarbon-containing resin material is thus manufactured by coating a resin-coated carbon nanomaterial with a second resin material by performing ultrasonic stirring using a second organic solvent that is primarily composed of tetrahydrofuran.

The carbon nanomaterial units come into contact with each other and aggregate when the carbon nanomaterial is directly mixed with a second resin material, but according to the second aspect of the present invention, the carbon nanomaterial is coated by a resin, and this resin material therefore acts as a barrier, and the carbon nanomaterial units are prevented from coming in contact with each other and aggregating.

In order to achieve these effects, the second resin material must be made into a liquid. A solvent is necessary to form a liquid, but in the second aspect of the present invention, an organic solvent primarily composed of tetrahydrofuran is employed out of consideration for the two aspects of toxicity and post-treatment.

The second organic solvent primarily composed of tetrahydrofuran has relatively low toxicity. The solvent can also be changed to an aqueous phase by mixing with water, and can easily be removed.

The second resin material is made into a liquid using such a second organic solvent primarily composed of tetrahydrofuran, and the resin-coated carbon nanomaterial is mixed into the solution. The resin-coated carbon nanomaterial can thereby be mixed with the resin material. The organic solvent is then removed by water, and the product is dried, whereby the nanocarbon-containing resin material can be obtained. This nanocarbon-containing resin material is suitable for use as an injection molding material.

Furthermore, in the second aspect of the present invention, because an ultrasonic stirring method can be employed, enhanced dispersion properties and reduced processing time can be anticipated in the nanocarbon dispersion step.

Preferably, the additive is an azo-based compound, or an amine-based complex for forming a complex with copper chloride.

Desirably, the second resin material includes at least one type of resin selected from polycarbonate resin, polystyrene resin, and polymethyl methacrylate resin. Polycarbonate resin, polystyrene resin, and polymethyl methacrylate resin are all materials that are easily obtainable, inexpensive, and soluble in an organic solvent primarily composed of tetrahydrofuran.

According to a third aspect of the present invention, there is provided a method for manufacturing a nanocarbon-containing resin material, the method comprising: a step of preparing a resin material and the resin-coated carbon nanomaterial manufactured by a method having a step of preparing a first organic solvent primarily composed of tetrahydrofuran, a polycarbonate resin as a first resin material to be dissolved in the first organic solvent, an additive having a functional group for dissolving an ester, and a carbon nanomaterial, further having a first resin dispersion step of mixing the polycarbonate resin with a portion of the first organic solvent, dissolving the polycarbonate resin in the first organic solvent, and obtaining a first resin dispersion solution, further having a first stirring step of adding the additive and the carbon nanomaterial to the resulting first resin dispersion solution, and stirring under reflux conditions to obtain a first nanocarbon/resin dispersion solution, further having a filtering step of filtering the resulting first nanocarbon/resin dispersion solution and obtaining a filtrate, further having a re-filtering step of adding a residue of the first organic solvent to the resulting filtrate, performing at least one re-filtration, and obtaining a re-filtrate, further having a washing step of washing the re-filtrate to remove excess polycarbonate resin from the resulting re-filtrate, and obtaining a washed product, and further having a first drying step of drying the resulting washed product and obtaining a carbon nanomaterial that is coated by a resin; and a mixing step of mixing the resin-coated carbon nanomaterial with the resin material while maintaining a temperature at which a surface of the resin material softens, and obtaining a resin material that contains the carbon nanomaterial.

The third aspect of the present invention is a so-called heated stirring method, and can be applied to polypropylene and other resin materials that are hardly soluble in an organic solvent.

Preferably, the additive is an azo-based compound, or an amine-based complex for forming a complex with copper chloride.

Desirably, the second resin material includes at least one type of resin selected from polypropylene resin, polyester resin, and polyacetal resin. Polypropylene resin, polyester resin, and polyacetal resin all do not dissolve in organic solvents that are primarily composed of tetrahydrofuran. Specifically, processing is possible even for a resin that does not dissolve in tetrahydrofuran, and the range of application of the manufacturing method can be increased.

According to a fourth aspect of the present invention, there is provided a method for manufacturing a carbon nanocomposite resin molding, the method comprising: a step of preparing the nanocarbon-containing resin material manufactured by a method having a second preparation step of preparing a second organic solvent primarily composed of tetrahydrofuran, a second resin material to be dissolved in the second organic solvent, water, and the resin-coated carbon nanomaterial manufactured by a method including a first preparation step of preparing a first organic solvent primarily composed of tetrahydrofuran, a polycarbonate resin as a first resin material to be dissolved in the first organic solvent, an additive having a functional group for dissolving an ester, and a carbon nanomaterial, further including a first resin dispersion step of mixing the polycarbonate resin with a portion of the first organic solvent, dissolving the polycarbonate resin in the first organic solvent, and obtaining a first resin dispersion solution, further including a first stirring step of adding the additive and the carbon nanomaterial to the resulting first resin dispersion solution, and stirring under reflux conditions to obtain a first nanocarbon/resin dispersion solution, further including a filtering step of filtering the resulting first nanocarbon/resin dispersion solution and obtaining a filtrate, further including a re-filtering step of adding a residue of the first organic solvent to the resulting filtrate, performing at least one re-filtration, and obtaining a re-filtrate, further including a washing step of washing the re-filtrate to remove excess polycarbonate resin from the resulting re-filtrate, and obtaining a washed product, and further including a first drying step of drying the resulting washed product and obtaining a carbon nanomaterial that is coated by a resin, further having a second resin dispersion step of mixing the second resin material with a portion of the second organic solvent, dissolving the second resin material in the second organic solvent, and obtaining a second resin dispersion solution, further having a nanocarbon dispersion step of obtaining a nanocarbon dispersion solution separately from the second resin dispersion step by mixing the resin-coated carbon nanomaterial with a residue of the second organic solvent and performing ultrasonic stirring, further having a second stirring step of stirring the resulting nanocarbon dispersion solution while dripping the nanocarbon dispersion solution into the second resin dispersion solution, and obtaining a second nanocarbon/resin dispersion solution, further having a solvent aqueous phase transition step of adding water to the resulting second nanocarbon/resin dispersion solution and changing a second organic solvent component to an aqueous phase, and further having a second drying step of removing the second organic solvent and obtaining a resin material that contains a carbon nanomaterial by drying the aqueous-phase-changed solution; and an injection molding step of obtaining a carbon nanocomposite resin molding by injection molding the nanocarbon-containing resin material.

In the fourth aspect of the present invention, a carbon-containing resin material formed by adding a resin-coated carbon material to the second resin material is used as an injection molding material. Because injection molding is performed using such a material, the carbon nanomaterial is satisfactorily dispersed in the resulting carbon nanocomposite resin molding, and high mechanical strength can be anticipated.

Preferably, the additive is an azo-based compound, or an amine-based complex for forming a complex with copper chloride.

Desirably, the second resin material includes at least one type of resin selected from polycarbonate resin, polystyrene resin, and polymethyl methacrylate resin.

According to a fifth aspect of the present invention, there is provided a method for manufacturing a carbon nanocomposite resin molding, comprising the steps of: preparing a nanocarbon-containing resin material by a method comprising the step of preparing a resin material and a resin-coated carbon nanomaterial manufactured by a method comprising: a step of preparing a first organic solvent primarily composed of tetrahydrofuran, a polycarbonate resin as a first resin material to be dissolved in the first organic solvent, an additive having a functional group for dissolving an ester, and a carbon nanomaterial; a first resin dispersion step of mixing the polycarbonate resin with a portion of the first organic solvent, dissolving the polycarbonate resin in the first organic solvent, and obtaining a first resin dispersion solution; a first stirring step of adding the additive and the carbon nanomaterial to the resulting first resin dispersion solution, and stirring under reflux conditions to obtain a first nanocarbon/resin dispersion solution; a filtering step of filtering the resulting first nanocarbon/resin dispersion solution and obtaining a filtrate; a re-filtering step of adding a residue of the first organic solvent to the resulting filtrate, performing at least one re-filtration, and obtaining a re-filtrate; a washing step of washing the re-filtrate to remove excess polycarbonate resin from the resulting re-filtrate, and obtaining a washed product; and a first drying step of drying the resulting washed product and obtaining a carbon nanomaterial that is coated by a resin; and mixing the resin-coated carbon nanomaterial with the resin material while maintaining a temperature at which a surface of the resin material softens, and obtaining a resin material that contains the carbon nanomaterial; and injection-molding the prepared nanocarbon-containing resin material into the carbon nanocomposite resin molding

In the fifth aspect of the present invention, a carbon-containing resin material formed by adding a resin-coated carbon material to a resin material is used as an injection molding material. Because injection molding is performed using such a material, the carbon nanomaterial is satisfactorily dispersed in the resulting carbon nanocomposite resin molding, and high mechanical strength can be anticipated.

Preferably, the additive is an azo-based compound, or an amine-based complex for forming a complex with copper chloride.

Desirably, the resin material includes at least one type of resin selected from polypropylene resin, polyester resin, and polyacetal resin.

### BRIEF DESCRIPTION OF THE DRAWINGS

Certain preferred embodiments of the present invention will be described in detail below, by way of example only, with reference to the accompanying drawings, in which:

FIG. 1(a) to (f) are diagrammatical views showing a first preparation step to a filtration step in the first step group of the present invention;

FIG. 2(a) to (f) are diagrammatical views showing a re-filtration step to a first drying step in the first step group;

FIG. 3(a) to (h) are diagrammatical views showing a second preparation step to a second drying step in the second step group of the present invention;

FIG. 4(a) to (c) are diagrammatical views showing a method of manufacturing a carbon nanocomposite resin molding according to the present invention;

FIG. 5 shows a third preparation step to a third mixing step in the third step group of the present invention;

FIG. 6 is a graph showing tensile strengths in Experiments (EXP.) 1 and 2;

FIG. 7 is a graph showing the mass of the resin-coated carbon nanomaterial in Experiments (EXP.) 1 to 3; and

FIG. 8 is a graph showing the tensile strengths in Experiments (EXP.) 4 and 5.

### DETAILED DESCRIPTION OF THE PREFERRED EMBODIMENTS

A first step group starting from the first preparation step, a second step group starting from the second preparation step, and a third step group starting from the third preparation step will be described hereinafter, but the third step group is a step group that follows directly from the first step group. Specifically, the sequence of steps is as follows: first step group→second step group→injection molding step, or first step group→third step group→injection molding step.

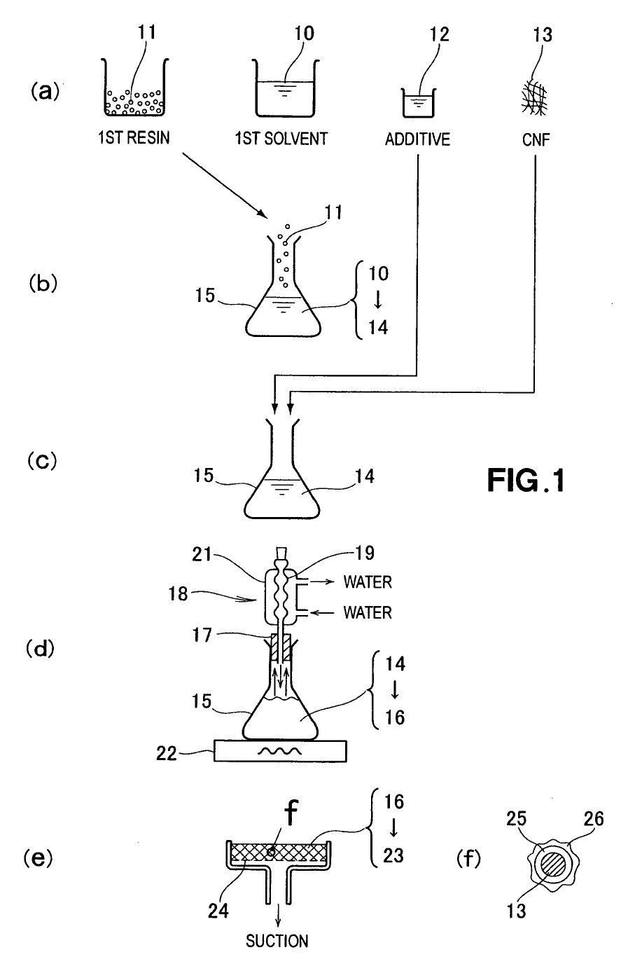

As shown in (a) of FIG. 1, a first organic solvent 10 primarily composed of tetrahydrofuran (hereinafter referred to as THF), a first resin material (i.e., polycarbonate resin) 11 to be dissolved in the first organic solvent, an additive 12 having a functional group for dissolving an ester, and a carbon nanomaterial 13 are prepared (first preparation step).

An azo-based compound or a copper chloride-amine-based complex is suitable as the additive 12.

Preferred examples of azo-based compounds are 2,2′-azobis-2,4-dimethylvaleronitrile, 2,2′-azobisisobutyronitrile, 2,2′-azobis-2-methylbutyronitrile, 1,1′-azobis-1-cyclohexanecarbonitrile, 2,2′-azobis-4-methoxy-dimethylvaleronitrile, 2,2′-azobis-N-2-(propenyl)-2-methylpropionamide, and the like.

The amine-based complex is an amine-based complex for forming a complex with copper chloride, and preferred examples thereof are ethylenediamine complexes, ethanolamine complexes, butylamine complexes, aniline complexes, benzylamine complexes, and the like.

As shown in FIG. 1(b), the first resin material (polycarbonate resin) 11 is mixed with a portion of the first organic solvent 10, the first resin material 11 is dissolved in the first organic solvent 10, and a first resin dispersion solution 14 is obtained (first resin dispersion step).

Specifically, 600 mL of the first organic solvent (THF) 10 is placed in a flask 15. A small amount at a time of the first resin material (polycarbonate) 11 is then added. The first resin dispersion solution 14 is obtained when the added quantity of the polycarbonate reaches 66.5 g.

The additive 12 and the carbon nanomaterial 13 are added to the first resin dispersion solution 14, as shown in FIG. 1(c). The solution is then stirred under reflux conditions, and a first nanocarbon/resin dispersion solution 16 is obtained, as shown in FIG. 1(d) (first stirring step).

Specifically, the solution stirred under reflux conditions is one in which 3.5 g of the carbon nanomaterial are added, and in which 15 mmol (millimoles) of 2,2′-azobisisobutyronitrile (AIBN) as the additive are added to the first resin dispersion solution 14 formed by dissolving 66.5 g of polycarbonate in 600 mL of THF.

Stirring under reflux conditions can be performed as follows.

As shown in FIG. 1(d), the top opening of the flask 15 is closed by a stopper 17. A water-cooled double pipe 18 is inserted from above the stopper 17. Cooling water is fed between the inner pipe 19 and the outer pipe 21 of the water-cooled double pipe 18. The flask 15 is heated by a heater 22. The first resin dispersion solution 14 then boils. Vapor rises into the inner pipe 19, is cooled and liquefied in the inner pipe 19, and drips into the flask 15. Such recirculation and boiling stirring are performed for 24 hours. As a result, the first nanocarbon/resin dispersion solution 16 can be obtained.

A radical forms in the case of an azo-based compound, and nucleophilic substitution (a reaction in which a nucleating agent nucleophilically attacks an atom that becomes the center of the reaction, and a leaving group separates) occurs in the case of a copper chloride-amine complex, due to stirring under reflux conditions as described above, and effects can be anticipated in which the ester group of the polycarbonate resin is decomposed.

As shown in FIG. 1(e), the resulting first nanocarbon/resin dispersion solution 16 is filtered, and a filtrate 23 is obtained (filtration step).

The cooled first nanocarbon/resin dispersion solution 16 is preferably poured on a filter paper 24, and a vacuum is applied under the filter paper 24. A pancake (disk)-shaped filtrate 23 can be obtained that is adequately free of the liquid component. This vacuum filtration method is capable of removing the liquid component more effectively and in a shorter time than a common gravitational filtration method.

FIG. 1(f) is an enlarged view of the filtrate 23 shown in FIG. 1(e). The carbon nanomaterial 13 is coated by a compact polycarbonate layer 25. The polycarbonate layer 25 is coated by a coarse excess polycarbonate layer 26. The excess polycarbonate layer 26 is removed by the re-filtration step described by the next diagram.

The film thickness of the compact polycarbonate layer 25 can be reduced by adding the additive 12. The effects of the additive 12 can be described in comparison to a common coating application. Specifically, the thickness of the coating film increases when only a coating material is used. When a diluent (thinner) is added to the coating material, the fluidity increases, and the coating film can be made thin. The diluent evaporates and disappears after use. The additive 12 used in the present invention demonstrates the effects of a diluent in coating application. The thickness of the polycarbonate layer 25 can therefore be reduced. The quantity of the first resin material 11 consumed can be reduced when the film thickness is low.

Polycarbonate is degraded by the application of ultrasonic waves, and the additive separates from the polycarbonate, which may result in reduced mechanical strength. An ultrasonic stirring method is therefore considered to be unsuitable for stirring polycarbonate.

However, it has been reliably confirmed that ultrasonic stirring can be applied even for polycarbonate when the composite stricture shown in FIG. 1(f) is formed. It is possible that the carbon nanomaterial 13 acts as a backup material or a reinforcing material for the polycarbonate layer 25.

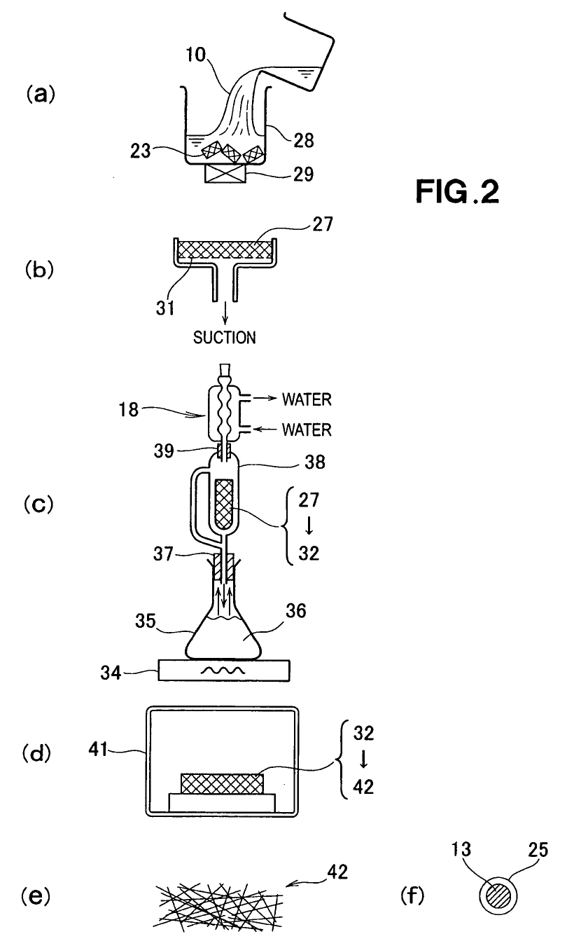

FIG. 2 shows the steps from the re-filtration step to the first drying step.

As shown in FIGS. 2(a) and 2(b), a residue of the first organic solvent 10 is added to the filtrate 23, at least one re-filtration is performed, and a re-filtrate 27 is obtained (re-filtration step).

Specifically, the filtrate 23 is appropriately crushed and placed in a vessel 28, as shown in FIG. 2(a). A residue of the first organic solvent 10 is poured into the vessel 28. The vessel 28 is then placed on an ultrasonic oscillator 29. When ultrasonic oscillation is performed for about 10 minutes, the filtrate 23 is satisfactorily dispersed in the first organic solvent 10. Most of the excess polycarbonate can thereby be dissolved.

The solution is then poured on a filter paper 31, and a vacuum is applied under the filter paper 31, as shown in FIG. 2(b). A pancake-shaped re-filtrate 27 can be obtained that is adequately free of the liquid component.

The re-filtration step is preferably performed two or more times by repeating the procedures shown in FIGS. 2(a) and 2(b) to accelerate removal of the excess polycarbonate.

The re-filtrate 27 is then washed to remove the first organic solvent 10 from the re-filtrate 27, as shown in FIG. 2(c), and a washed product 32 is obtained (washing step).

Soxhlet extraction is suitable for the washing step. In Soxhlet extraction, an appropriate quantity of a washing solution (THF) 36 is placed in a flask 35 mounted on a heater 34, the top opening of the flask 35 is closed by a stopper 37, and an extraction tube 38 is inserted into the stopper 37. The re-filtrate 27 is placed in the extraction tube 38. The top opening of the extraction tube 38 is closed by a stopper 39, and a water-cooled double pipe 18 is inserted from above the stopper 39.

The flask 35 is heated by the heater 34, whereupon, the washing solution 36 boils. Vapor rises, passes through the re-filtrate 27, and reaches the water-cooled double pipe 18, and is there cooled and liquefied, and returns to the flask 35. Such boiling, recirculation, and washing are performed for 24 hours. As a result, the washed product 32 can be obtained.

The resulting washed product 32 is placed in a dryer 41 at 100° C., as shown in FIG. 2(d), and dried for about 24 hours, whereby a carbon nanomaterial (resin-coated carbon nanomaterial) 42 coated by resin is obtained (first drying step).

This resin-coated carbon nanomaterial 42 is finely crushed. The crushed resin-coated carbon nanomaterial 42 becomes an acicular or fibrous substance, as shown in FIG. 2(e). When the resin-coated carbon nanomaterial 42 is magnified, the carbon nanomaterial 13 is covered by a compact polycarbonate layer 25, as shown in FIG. 2(f). The polycarbonate layer 25 is coated onto the periphery of the carbon nanomaterial 13 according to a II II stacking interaction.

A molding material that is suitable for injection molding is manufactured using the resin-coated carbon nanomaterial 42 obtained by the manufacturing method described above as a starting material. The method of manufacture is described hereinafter.

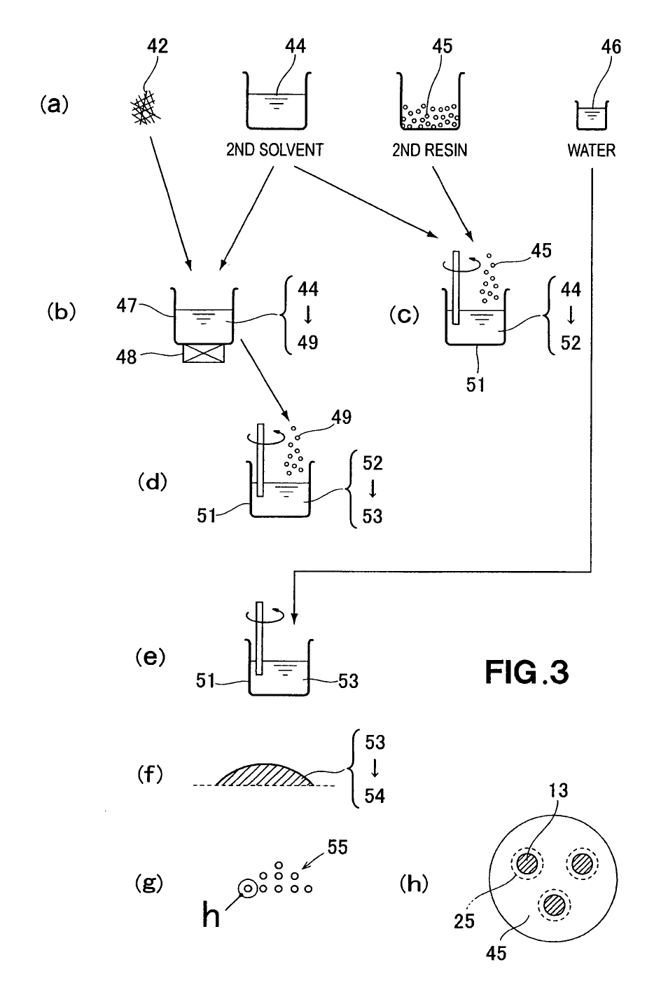

FIG. 3 shows the steps from the second preparation step to the second drying step.

As shown in FIG. 3(a), the resin-coated carbon nanomaterial 42, a second organic solvent 44 primarily composed of tetrahydrofuran, a second resin material 45 to be dissolved in the second organic solvent 44, and water 46 are prepared (second preparation step).

The second resin material 45 may be any type of resin that dissolved in THF, but polycarbonate resin, polystyrene resin, or polymethyl methacrylate resin is inexpensive and easily obtained, and is therefore suitable. The second resin material 45 may also be a resin material in which two or more types of resin are mixed together.

A vessel 47 is then filled with a portion of the second organic solvent 44, as shown in FIG. 3(b), the resin-coated carbon nanomaterial 42 is placed in the vessel, and ultrasonic stirring is performed using an ultrasonic oscillator 48, whereby a nanocarbon dispersion solution 49 is obtained (nanocarbon dispersion step).

Specifically, 400 mL of THF are placed in the vessel 47, 0.7 g of the resin-coated carbon nanomaterial 42 is placed in the vessel, and ultrasonic stirring is performed for three hours, whereby the nanocarbon dispersion solution 49 is obtained. Since the stirring is ultrasonic, a nanocarbon dispersion solution 49 that is satisfactorily dispersed can be obtained in a short time.

As shown in FIG. 3(c) parallel to FIG. 3(b), the second resin material 45 and a residue of the second organic solvent 44 are placed in a vessel 51, the second resin material 45 is dissolved in the second organic solvent 44, and a second resin dispersion solution 52 is obtained (second resin dispersion step).

Specifically, 500 mL of THF are placed in the vessel 51, and the polycarbonate is added in small amounts at a time. When the added amount reaches 69.3 g, the second resin dispersion solution 52 is obtained.

Stirring is then performed for about one hour while the nanocarbon dispersion solution 49 is dripped into the second resin dispersion solution 52 in the vessel 51, as shown in FIG. 3(d), and a second nanocarbon/resin dispersion solution 53 is obtained (second stirring step).

As shown in FIG. 3(e), water 46 is added to the second nanocarbon/resin dispersion solution 53, and the second organic solvent component is changed to the aqueous phase (solvent aqueous phase transition step).

The second nanocarbon/resin dispersion solution 53 is then filtered and dried, and a nanocarbon-containing resin material 54 is obtained, as shown in FIG. 3(f) (second drying step).

The dried nanocarbon-containing resin material 54 is crushed and dried as needed, and the nanocarbon-containing resin material powder 55 shown in FIG. 3(g) is obtained.

FIG. 3(h) is an enlarged view showing the portion indicated by the reference symbol h in FIG. 3(g). In the powder 55, the carbon nanomaterial 13 coated by the polycarbonate layer 25 is mixed with the second resin material (polycarbonate) 45 as the base material. The polycarbonate layer 25 is integrated with the second resin material (polycarbonate) 45 as the base material, as indicated by the dashed lines. Even in this form, the carbon nanomaterial 13 is considered to be present in the second resin material (polycarbonate) 45 as the base material through II II interaction.

The method for manufacturing an injection molding using the resulting nanocarbon-containing resin material powder 55 will next be described.

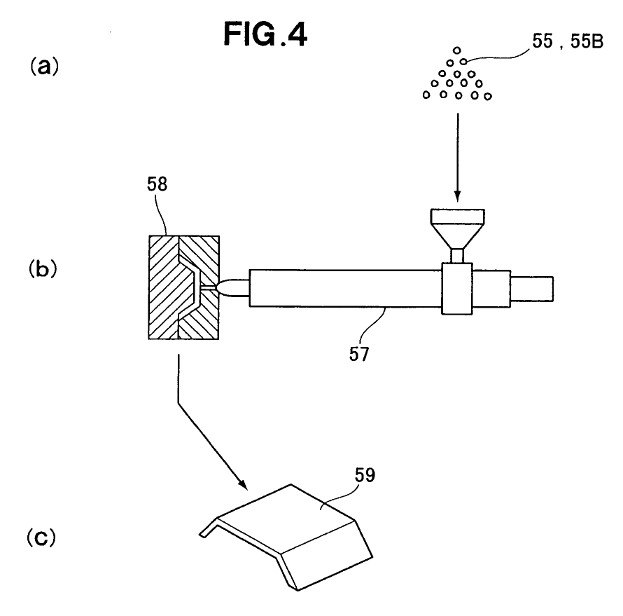

FIG. 4 shows the method for manufacturing a carbon nanocomposite resin molding.

As shown in FIG. 4(a), the nanocarbon-containing resin material powder 55 is prepared. The prepared nanocarbon-containing resin material powder 55 is fed to an injection molding machine 57 as shown in FIG. 4(b). The powder 55 is kneaded, plasticized, and injected into a die 58 in the injection molding machine 57 (injection molding step).

As a result, a carbon nanocomposite resin molding 59 can be obtained, as shown in FIG. 4(c).

The starting material (nanocarbon-containing resin material powder 55) in FIG. 4 can be manufactured by the heated stirring method described below.

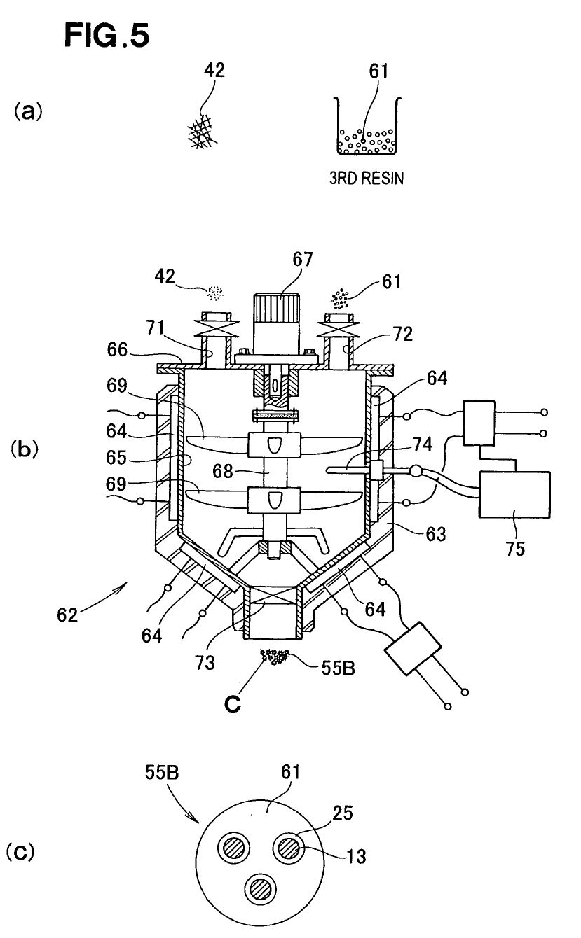

FIG. 5 shows the steps from the third preparation step to the third mixing step.

As shown in FIG. 5(a), the resin-coated carbon nanomaterial 42 and a third resin material 61 are prepared (third preparation step).

The third resin material 61 characteristically includes at least one type of resin selected from polypropylene resin, polyester resin, and polyacetal resin. Polypropylene resin, polyester resin, and polyacetal resin all do not dissolve in organic solvents that are primarily composed of tetrahydrofuran. Specifically, according to the present invention, processing is possible even for a resin that does not dissolve in tetrahydrofuran, and the range of application of the manufacturing method can be increased.

The resin-coated carbon nanomaterial 42 and the third resin material 61 are then mixed in the heated stirring device 62 shown in FIG. 5(b) while a temperature is maintained at which the surface of the third resin material 61 softens, and a nanocarbon-containing resin material 55B is obtained (third mixing step).

Specifically, the heated stirring device 62 is composed of a cylindrical vessel 65 that is insulated by a heat insulating material 63 and provided with a plurality of heaters 64; a lid 66 for blocking the top opening of the cylindrical vessel 65; a motor 67 provided to the upper part of the center of the lid 66; a rotary shaft 68 suspended from a shaft of the motor 67; stirring vanes 69 provided to the rotary shaft 68 that pivot inside the cylindrical vessel 65; a first introduction opening 71 and a second introduction opening 72 provided to the lid 66; a valve 73 provided to the lower part of the cylindrical vessel 65; a thermometer 74 affixed to the cylindrical vessel 65 to measure the internal temperature of the cylindrical vessel 65; and a control unit 75 for comparing a set temperature with temperature information detected by the thermometer 74 and controlling the output of the heaters 64.

The resin-coated carbon nanomaterial 42 is introduced from the first introduction opening 71, the third resin material 61 is introduced from the second introduction opening 72, a high temperature is maintained inside the cylindrical vessel 65, and stirring is performed by the stirring vanes 69, whereby the resin-coated carbon nanomaterial 42 is dispersed in the third resin material 61.

In the nanocarbon-containing resin material 55B, the carbon nanomaterial 13 is covered by the polycarbonate layer 25, and the polycarbonate layer 25 is surrounded by the base material third resin material 61, as shown in FIG. 5(c).

Since the polycarbonate layer 25 is coated by the carbon nanomaterial 13 by II II interaction, and the polycarbonate layer 25 is bonded to the third resin material 61, the carbon nanomaterial 13 is strongly integrated in the third resin material 61.

The carbon nanocomposite resin molding 59 can be obtained by feeding a nanocarbon-containing resin material 55B such as the one described above into the injection molding machine 57 shown in FIG. 4 and performing the injection molding step.

### EXPERIMENTAL EXAMPLES

Experimental examples of the present invention will be described hereinafter. The present invention is in no way limited by the experimental examples.

### Experiment 1 and Experiment 2:

Materials were prepared in the first preparation step as shown in Table 1 below.

TABLE 1

| | First preparation step | | | | | | Second preparation step | | | | |
|---|---|---|---|---|---|---|---|---|---|---|---|
| Experiment | First | First | | Carbon | | Resin-coated carbon | Resin-coated | Second | Second | Proc- | Tensile |
| No. | resin | solvent | Additive | nanomaterial | Processing | nanomaterial | CNF | solvent | resin | essing | strength |
| Experiment 1 | PC | THF | AIBN | 3.5 g | FIG. 1, | 3.56 g | 0.7 g | THF | PC | FIG. 3, | 63.2 MPa |
| | 66.5 g | 600 mL | 15 mmol | | FIG. 2 | | | 900 mL | 69.3 g | FIG. 4 | |
| Experiment 1 | PC | THF | | 3.5 g | FIG. 1, | 3.98 g | 0.7 g | THF | PC | FIG. 3, | 60.7 MPa |
| | 66.5 g | 600 mL | | | FIG. 2 | | | 900 mL | 69.3 g | FIG. 4 | |

### Experiment 1:

In Experiment 1, 66.5 g of PC (polycarbonate) as the first resin, 600 mL of THF as the first solvent, 15 mmol of AIBN (2,2′-azobisisobutyronitrile) as the additive, and 3.5 g of a carbon nanomaterial were prepared and processed as shown in FIGS. 1 and 2, and a resin-coated carbon nanomaterial was obtained. The mass of the resulting resin-coated carbon nanomaterial was 3.56 g. From this resin-coated carbon nanomaterial, 0.7 g was taken out and used in the second preparation step.

In the second preparation step, 0.7 g of resin-coated CNF (carbon nanomaterial), 900 mL of THF as the second solvent, and 69.3 g of PC (polycarbonate) as the second resin were prepared. These substances were processed as shown in FIGS. 3 and 4, and an injection molding (carbon nanocomposite resin molding) was obtained. The tensile strength of the resulting molding was 63.2 MPa.

### Experiment 2:

Experiment 2 was a contrasting experiment with respect to Experiment 1. The additive (AIBN) used in Experiment 1 was not used in Experiment 2. Other aspects were the same as in Experiment 1. The tensile strength of the molding obtained in Experiment 2 was 60.7 MPa.

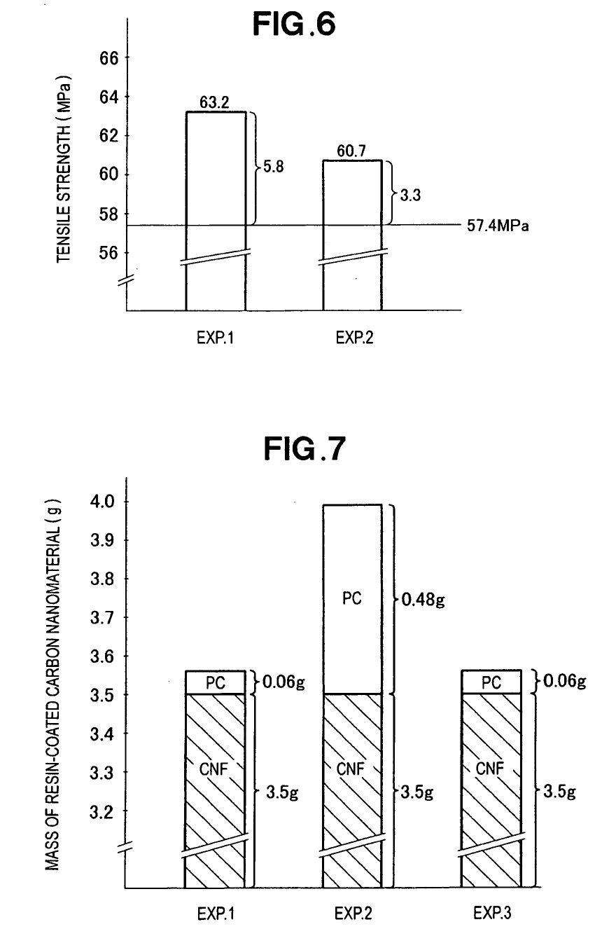

FIG. 6 is a graph showing the tensile strength in Experiments 1 and 2.

The tensile strength of PC (polycarbonate) alone is 57.4 MPa, as is publicly known. In contrast, the tensile strength in Experiment 1 was 63.2 MPa, which represents a strength increase of 5.8 MPa (=63.2−57.4), and the tensile strength in Experiment 2 was 60.7 MPa, which represents a strength increase of 3.3 MPa (=60.7−57.4).

As shown in the “resin-coated carbon nanomaterial” column in the center of Table 1, the mass of the resin-coated carbon nanomaterial obtained in Experiment 1 was 3.56 g, whereas the mass of the resin-coated carbon nanomaterial obtained in Experiment 2 was 3.98 g. It is therefore apparent that the thickness of the polycarbonate layer in the resin-coated carbon nanomaterial obtained in Experiment 2 was significantly larger.

This difference is considered to be due to the fact that the additive (AIBN) was used in Experiment 1, whereas the additive was not used in Experiment 2.

Therefore, an additive other than AIBN was tested in order to confirm the use of the additive.

### Experiment 3:

Materials were prepared in the first preparation step as shown in Table 2 below.

TABLE 2

| | First preparation step | | | | | Resin-coated |
|---|---|---|---|---|---|---|
| Experiment | | First | | Carbon | | carbon |
| No. | First resin | solvent | Additive | nanomaterial | Processing | nanomaterial |
| Experiment 3 | PC | THF | CuCl | 3.5 g | FIG. 1, | 3.56 g |
| | 66.5 g | 600 mL | 15 mmol | | FIG. 2 | |
| | | | Ethylenediamine | | | |
| | | | 50 mmol | | | |

Specifically, the AIBN in Experiment 1 was substituted with an amine-based complex for forming a complex with copper chloride in Experiment 3. Specifically, the additives used in Experiment 3 were 15 mmol of copper chloride (CuCl) and 50 mmol of ethylenediamine. Other conditions were the same as in Example 1.

The mass of the resin-coated carbon nanomaterial obtained in Experiment 3 was 3.56 g.

FIG. 7 is a graph showing the mass of the resin-coated carbon nanomaterial in Experiments 1 through 3.

In Experiment 1, a 0.06 g PC (polycarbonate) layer was bonded to 3.5 g of CNF (carbon nanomaterial).

In Experiment 2, a 0.48 g PC layer was bonded to 3.5 g of CNF.

In Experiment 3, a 0.06 g PC layer was bonded to 3.5 g of CNF.

The additive was added in Experiments 1 and 3, and was not added in Experiment 2, but it is apparent from FIG. 7 that adding the additive as in Experiments 1 and 3 is effective in terms of obtaining a compact PC layer and reducing the consumed amount of PC.

The effects of the heated stirring method described using FIG. 5 were then confirmed by experimentation.

### Experiments 4 and 5:

Materials were prepared in the first preparation step as shown in Table 3 below.

TABLE 3

| | First preparation step | | | | | | Third preparation step | | | | |
|---|---|---|---|---|---|---|---|---|---|---|---|
| Experiment | First | First | | Carbon | | Resin-coated carbon | Resin-coated | Uncoated | Third | Proc- | Tensile |
| No. | resin | solvent | Additive | nanomaterial | Processing | nanomaterial | CNF | CNF | resin | essing | strength |
| Experiment 4 | PC | THF | AIBN | 3.5 g | FIG. 1, | 3.56 g | 5 g | | PP | FIG. 5, | 33.8 MPa |
| | 66.5 g | 600 mL | 15 mmol | | FIG. 2 | | | | 95 g | FIG. 4 | |
| Experiment 5 | | | | | | | | 5 g | PP | FIG. 5, | 32.1 MPa |
| | | | | | | | | | 95 g | FIG. 4 | |

In Experiment 4, 3.56 g of resin-coated carbon nanomaterial were obtained by processing the same materials as those of Experiment 1 on the basis of FIGS. 1 and 2. From this resin-coated carbon nanomaterial, 5 g were used in the third preparation step. In the third preparation step, 5 g of the resin-coated carbon nanomaterial and 95 g of PP (polypropylene) as the third resin were prepared. An injection molding (carbon nanocomposite resin molding) was obtained by performing the processing shown in FIGS. 5 and 4. The tensile strength of the resulting molding was 33.8 MPa.

### Experiment 5:

Experiment 5 was a contrasting experiment with respect to Experiment 4. An injection molding (carbon nanocomposite resin molding) was obtained by performing the processing shown in FIGS. 5 and 4 using 5 g of uncoated CNF (carbon nanomaterial) and 95 g of PP as starting materials. The tensile strength of the resulting molding was 32.1 MPa.

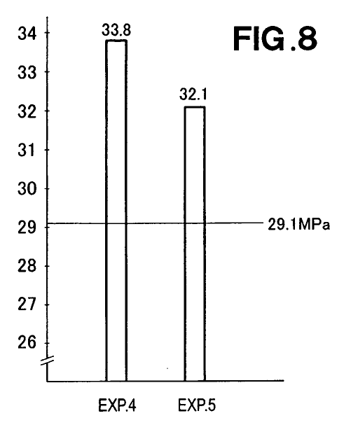

FIG. 8 is a graph showing the tensile strength in Experiments 4 and 5.

The tensile strength of PP (polypropylene) alone is 29.1 MPa, as is publicly known. In contrast, the tensile strength in Experiment 4 was 33.8 MPa, and the tensile strength in Experiment 5 was 32.1 MPa.

Since the strength in Experiment 4 was higher than in Experiment 5, it was confirmed that a stronger molding was obtained in Experiment 4 in which the resin-coated carbon nanomaterial was used than in Experiment 5, in which the uncoated carbon nanomaterial was used.

As described above, the carbon nanomaterial coated by a resin according to the present invention is suitable as an injection molding material.

What is claimed is:

1. A method for manufacturing a resin-coated carbon nanomaterial, comprising:
a first preparation step of preparing a first organic solvent primarily composed of tetrahydrofuran, a polycarbonate resin as a first resin material to be dissolved in the first organic solvent, an additive having a functional group for dissolving an ester, and a carbon nanomaterial;
a first resin dispersion step of mixing the polycarbonate resin with a portion of the first organic solvent, dissolving the polycarbonate resin in the first organic solvent, and obtaining a first resin dispersion solution;
a first stirring step of adding the additive and the carbon nanomaterial to the resulting first resin dispersion solution, and stirring under reflux conditions to obtain a first nanocarbon/resin dispersion solution;
a filtering step of filtering the resulting first nanocarbon/resin dispersion solution and obtaining a filtrate;
a re-filtering step of adding a residue of the first organic solvent to the resulting filtrate, performing at least one re-filtration, and obtaining a re-filtrate;
a washing step of washing the re-filtrate to remove excess polycarbonate resin from the resulting re-filtrate, and obtaining a washed product; and
a first drying step of drying the resulting washed product and obtaining a carbon nanomaterial that is coated by a resin.

2. The manufacturing method of claim 1, wherein the additive is an azo-based compound, or an amine-based complex for forming a complex with copper chloride.

3. A method for manufacturing a nanocarbon-containing resin material, comprising:
a second preparation step of preparing a second organic solvent primarily composed of tetrahydrofuran, a second resin material to be dissolved in the second organic solvent, water, and the resin-coated carbon nanomaterial manufactured by a method comprising:
a first preparation step of preparing a first organic solvent primarily composed of tetrahydrofuran, a polycarbonate resin as a first resin material to be dissolved in the first organic solvent, an additive having a functional group for dissolving an ester, and a carbon nanomaterial;
a first resin dispersion step of mixing the polycarbonate resin with a portion of the first organic solvent, dissolving the polycarbonate resin in the first organic solvent, and obtaining a first resin dispersion solution;
a first stirring step of adding the additive and the carbon nanomaterial to the resulting first resin dispersion solution, and stirring under reflux conditions to obtain a first nanocarbon/resin dispersion solution;
a filtering step of filtering the resulting first nanocarbon/resin dispersion solution and obtaining a filtrate;
a re-filtering step of adding a residue of the first organic solvent to the resulting filtrate, performing at least one re-filtration, and obtaining a re-filtrate;
a washing step of washing the re-filtrate to remove excess polycarbonate resin from the resulting re-filtrate, and obtaining a washed product; and
a first drying step of drying the resulting washed product and obtaining a carbon nanomaterial that is coated by a resin;
a second resin dispersion step of mixing the second resin material with a portion of the second organic solvent, dissolving the second resin material in the second organic solvent, and obtaining a second resin dispersion solution;
a nanocarbon dispersion step of obtaining a nanocarbon dispersion solution separately from the second resin dispersion step by mixing the resin-coated carbon nanomaterial with a residue of the second organic solvent and performing ultrasonic stirring;
a second stirring step of stirring the resulting nanocarbon dispersion solution while dripping the nanocarbon dispersion solution into the second resin dispersion solution, and obtaining a second nanocarbon/resin dispersion solution;
a solvent aqueous phase transition step of adding water to the resulting second nanocarbon/resin dispersion solution and changing a second organic solvent component to an aqueous phase; and
a second drying step of removing the second organic solvent and obtaining a resin material that contains a carbon nanomaterial by drying the aqueous-phase-changed solution.

4. The manufacturing method of claim 3, wherein the additive is an azo-based compound, or an amine-based complex for forming a complex with copper chloride.

5. The manufacturing method of claim 3, wherein the second resin material includes at least one type of resin selected from polycarbonate resin, polystyrene resin, and polymethyl methacrylate resin.

6. A method for manufacturing a nanocarbon-containing resin material, comprising:
a step of preparing a resin material, and the resin-coated carbon nanomaterial manufactured by a method comprising:
a step of preparing a first organic solvent primarily composed of tetrahydrofuran, a polycarbonate resin as a first resin material to be dissolved in the first organic solvent, an additive having a functional group for dissolving an ester, and a carbon nanomaterial;
a first resin dispersion step of mixing the polycarbonate resin with a portion of the first organic solvent, dissolving the polycarbonate resin in the first organic solvent, and obtaining a first resin dispersion solution;
a first stirring step of adding the additive and the carbon nanomaterial to the resulting first resin dispersion solution, and stirring under reflux conditions to obtain a first nanocarbon/resin dispersion solution;
a filtering step of filtering the resulting first nanocarbon/resin dispersion solution and obtaining a filtrate;
a re-filtering step of adding a residue of the first organic solvent to the resulting filtrate, performing at least one re-filtration, and obtaining a re-filtrate;
a washing step of washing the re-filtrate to remove excess polycarbonate resin from the resulting re-filtrate, and obtaining a washed product; and
a first drying step of drying the resulting washed product and obtaining a carbon nanomaterial that is coated by a resin; and
a mixing step of mixing the resin-coated carbon nanomaterial with the resin material while maintaining a temperature at which a surface of the resin material softens, and obtaining a resin material that contains the carbon nanomaterial.

7. The manufacturing method of claim 6, wherein the additive is an azo-based compound, or an amine-based complex for forming a complex with copper chloride.

8. The manufacturing method according to claim 6, wherein the resin material includes at least one type of resin selected from polypropylene resin, polyester resin, and polyacetal resin.

9. A method for manufacturing a carbon nanocomposite resin molding, comprising:
a step of preparing the nanocarbon-containing resin material manufactured by a method including:
a second preparation step of preparing a second organic solvent primarily composed of tetrahydrofuran, a second resin material to be dissolved in the second organic solvent, water, and the resin-coated carbon nanomaterial manufactured by a method comprising:
a first preparation step of preparing a first organic solvent primarily composed of tetrahydrofuran, a polycarbonate resin as a first resin material to be dissolved in the first organic solvent, an additive having a functional group for dissolving an ester, and a carbon nanomaterial;
a first resin dispersion step of mixing the polycarbonate resin with a portion of the first organic solvent, dissolving the polycarbonate resin in the first organic solvent, and obtaining a first resin dispersion solution;
a first stirring step of adding the additive and the carbon nanomaterial to the resulting first resin dispersion solution, and stirring under reflux conditions to obtain a first nanocarbon/resin dispersion solution;
a filtering step of filtering the resulting first nanocarbon/resin dispersion solution and obtaining a filtrate;
a re-filtering step of adding a residue of the first organic solvent to the resulting filtrate, performing at least one re-filtration, and obtaining a re-filtrate;
a washing step of washing the re-filtrate to remove excess polycarbonate resin from the resulting re-filtrate, and obtaining a washed product; and
a first drying step of drying the resulting washed product and obtaining a carbon nanomaterial that is coated by a resin;
a second resin dispersion step of mixing the second resin material with a portion of the second organic solvent, dissolving the second resin material in the second organic solvent, and obtaining a second resin dispersion solution;
a nanocarbon dispersion step of obtaining a nanocarbon dispersion solution separately from the second resin dispersion step by mixing the resin-coated carbon nanomaterial with a residue of the second organic solvent and performing ultrasonic stirring;
a second stirring step of stirring the resulting nanocarbon dispersion solution while dripping the nanocarbon dispersion solution into the second resin dispersion solution, and obtaining a second nanocarbon/resin dispersion solution;
a solvent aqueous phase transition step of adding water to the resulting second nanocarbon/resin dispersion solution and changing a second organic solvent component to an aqueous phase;
a second drying step of removing the second organic solvent and obtaining a resin material that contains a carbon nanomaterial by drying the aqueous-phase-changed solution; and
an injection molding step of obtaining a carbon nanocomposite resin molding by injection molding the nanocarbon-containing resin material.

10. The manufacturing method of claim 9, wherein the additive is an azo-based compound, or an amine-based complex for forming a complex with copper chloride.

11. The manufacturing method of claim 9, wherein the second resin material includes at least one type of resin selected from polycarbonate resin, polystyrene resin, and polymethyl methacrylate resin.

12. A method for manufacturing a carbon nanocomposite resin molding, comprising the steps of:
preparing a nanocarbon-containing resin material by a method comprising the step of:
preparing a resin material and a resin-coated carbon nanomaterial manufactured by a method comprising:
a step of preparing a first organic solvent primarily composed of tetrahydrofuran, a polycarbonate resin as a first resin material to be dissolved in the first organic solvent, an additive having a functional group for dissolving an ester, and a carbon nanomaterial;
a first resin dispersion step of mixing the polycarbonate resin with a portion of the first organic solvent, dissolving the polycarbonate resin in the first organic solvent, and obtaining a first resin dispersion solution;
a first stirring step of adding the additive and the carbon nanomaterial to the resulting first resin dispersion solution, and stirring under reflux conditions to obtain a first nanocarbon/resin dispersion solution;
a filtering step of filtering the resulting first nanocarbon/resin dispersion solution and obtaining a filtrate;
a re-filtering step of adding a residue of the first organic solvent to the resulting filtrate, performing at least one re-filtration, and obtaining a re-filtrate;
a washing step of washing the re-filtrate to remove excess polycarbonate resin from the resulting re-filtrate, and obtaining a washed product; and
a first drying step of drying the resulting washed product and obtaining a carbon nanomaterial that is coated by a resin; and
mixing the resin-coated carbon nanomaterial with the resin material while maintaining a temperature at which a surface of the resin material softens, and obtaining a resin material that contains the carbon nanomaterial; and
injection-molding the prepared nanocarbon-containing resin material into the carbon nanocomposite resin molding

13. The manufacturing method of claim 12, wherein the additive is an azo-based compound, or an amine-based complex for forming a complex with copper chloride.

14. The manufacturing method of claim 12, wherein the resin material includes at least one type of resin selected from polypropylene resin, polyester resin, and polyacetal resin.
